(19) United States
(12) Patent Application Publication
(10) Pub. No.: US 2024/0132167 A1
(43) Pub. Date: Apr. 25, 2024

(54) MOTOR STALL AND TRAILER LIFT

(71) Applicant: Outrider Technologies, Inc., Brighton, CO (US)

(72) Inventors: Ira Alexander Renfrew, Lexington, MA (US); Luciano Spinello, San Jose, CA (US); James McKenna, Brighton, CO (US); Tessa Ronan, Denver, CO (US); Vittorio Ziparo, Golden, CO (US); Lawrence Klein, Bend, OR (US); Ky Woodard, Denver, CO (US)

(21) Appl. No.: 18/401,061

(22) Filed: Dec. 29, 2023

Related U.S. Application Data
(63) Continuation-in-part of application No. 18/380,473, filed on Oct. 16, 2023.
Application No. 18/380,473 is a continuation of application No. 17/848,152, filed on Jun. 23, 2022, now Pat. No. 11,787,486.
(60) Provisional application No. 63/214,225, filed on Jun. 23, 2021.

(51) Int. Cl. B62D 49/00; B62D 53/08; B62D 53/12

(52) U.S. Cl. CPC B62D 49/007; B62D 53/0821; B62D 53/12

(57) ABSTRACT

Systems and methods determines that a trailer being towed by an autonomous electric tractor has its brakes applied when a motor current value of a drive motor of the autonomous electric tractor reaches or exceeds a first current threshold. a recover handler initiates a set of actions to recover resolve the trailer brake problem. A trailer lift status indicating whether a landing gear of the trailer is off the ground and a lift metric indicative of a height of the landing gear off the ground are determined by a perception module using one or more of images, point clouds, and radar data that include the trailer.

### RELATED APPLICATION

This application is a continuation-in-part of U.S. patent application Ser. No. 18/380,473 filed Oct. 16, 2023, which is a continuation of U.S. patent application Ser. No. 17/848,152 filed Jun. 23, 2022 (now U.S. Pat. No. 11,787,486), which claims priority to U.S. Patent Application No. 63/214,225, titled “Motor Stall and Trailer Lift,” filed Jun. 23, 2021, each of which is incorporated herein by reference in its entirety.

### BACKGROUND

Trucks are an essential part of modern commerce. These trucks transport materials and finished goods across the continent within their large interior spaces. Such goods are loaded and unloaded at various facilities that can include manufacturers, ports, distributors, retailers, and end users. The start and end locations are referred to as “yards” and include areas that trailers are parked (and/or staged) and moved to and from for access by tractors (trucks) for loading to a dock door for loading/unloading cargo into the associated facility, leaving the yard for travel to its destination, or entering the yard from its destination. Autonomous yard vehicles technology includes tractors (trucks) that are capable of automatically (without human intervention, or with human intervention via teleoperation) coupling, decoupling, and maneuvering trailers that are within the yard.

Safety is of upmost importance in such automated yards. The automatic maneuvering of said trailers results in situations where, if a person or other obstacle is in the intended path of the trailer or tractor, because there is no human operating the tractor, there are situations where the tractor may not know of a human or obstacle. Thus, additional sensors are desired so that the controller of the automated tractor can maneuver the trailers safely.

Additional difficulties arise because various manufactures and freight companies have their own trailers. Thus, while an automated yard vehicle may have associated sensors, it is difficult to utilize sensors on the trailers themselves because it requires human (or machine) intervention on the trailer prior to maneuvering the trailer. This additional intervention step is timely and creates an additional location for safety concern.

### SUMMARY

Trucks are an essential part of modern commerce. These trucks transport materials and finished goods across the continent within their large interior spaces. Such goods are loaded and unloaded at various facilities that can include manufacturers, ports, distributors, retailers, and end users. Large over-the road (OTR) trucks typically consist of a tractor or cab unit and a separate detachable trailer that is interconnected removably to the cab via a hitching system that consists of a so-called fifth-wheel and a kingpin.

Further challenges in trucking relate to docking, loading and unloading of goods to and from trailers. Warehouses and good distribution facilities have yards with multiple loading docks, and the trailer is positioned at one of the loading docks for loading and unloading. In an automated yard, the OTR truck stops at a designated location in staging area of the yard, and the OTR tractor detaches, leaving the trailer at the designated location. An autonomous tractor moves the trailer to a first one of the loading docks for unloading and/or loading. Another, or the same, autonomous tractor moves the trailer away from the loading dock when loading and/or unloading is complete, and parked in a designated location of the staging area. The trailer may also be moved between loading docks if needed by another, or the same, autonomous tractor. Another, or the same, OTR tractor couples with the trailer and the OTR truck departs the yard for another destination.

When movement of an autonomous electric tractor is impeded, a drive motor of the autonomous electric tractor stalls. A safety feature deactivates the autonomous electric tractor when the drive motor stall is detected for more than a preset period, such as five seconds, requiring that the autonomous electric tractor is manually reactivated. One aspect of the present embodiments includes the realization that not all drive motor stalls indicate a safety problem, and that during autonomous operation of the autonomous electric tractor in the yard, a motor stall may occur during normal operation of the autonomous electric tractor, and that deactivation of the autonomous electric tractor is undesirable. The present embodiments solve this problem by detecting when the drive motor stalls and commanding zero throttle to prevent the safety feature from deactivating the autonomous electric tractor. Advantageously, the autonomous electric tractor is not deactivated and does not require manual reactivation. Further, based upon an activity of the autonomous electric tractor when the stall is detected, the activity may be retried and/or modified to prevent the drive motor from stalling. Although the examples used herein are for an autonomous electric tractor, similar detection and actions may be applied to autonomous tractors with combustions engines without departing from the scope hereof.

The autonomous tractor does not retract the landing gear of the trailer when maneuvering the trailer within the yard, but raises a fifth-wheel of the autonomous tractor, when coupled with the trailer, to elevate the front end of the trailer and lift the landing gear off the ground. Another aspect of the present embodiments includes the realization that the landing gear of the trailer is not set to a standard height by a driver of the OTR truck when the trailer is deposited in the designated location of the staging area, and therefore the autonomous tractor does not know how high to lift the front end of the trailer to achieve a desired ground clearance for the landing gear. The present embodiments solve this problem by detecting a point when the landing gear leaves the ground as the autonomous tractor lifts the front end of the trailer and continues to raise the fifth-wheel a distance beyond the detected point to achieve a desired height of the landing gear above ground level. Advantageously, the autonomous tractor lifts the front of the trailer such that the landing gear clears obstacles in the yard without raising the front of the trailer higher than needed.

In one embodiment, a method detects and prevents stall of a drive motor of an autonomous electric tractor. The method includes receiving, at intervals, a motor current value from a drive circuit of the autonomous electric tractor and determining when the motor current value reaches or exceeds a first current threshold. When the motor current value reaches or exceeds the first current threshold, the method applies brakes and inhibits a throttle controlling the drive motor.

In another embodiment, a method prevents stall of a motor of an autonomous vehicle. A motor current value is received at intervals from a drive circuit of the autonomous electric tractor. When the motor current value reaches or exceeds a first current threshold, brakes are applied and a throttle controlling the drive motor is inhibited for a predefined period from the determining the motor current value reached or exceeded the first current, and then the throttle is uninhibited.

In another embodiment, a method determines height above the ground of a landing gear of a trailer coupled with a tractor. A hydraulic pump is controlled to pump a hydraulic fluid into a chamber of a piston coupled to a fifth-wheel of the tractor to raise the fifth-wheel. As the fifth-wheel rises, at intervals, a pressure value of the hydraulic fluid in the chamber is sensed. The pressure values are processed to determine when the landing gear is lifted off the ground.

In certain embodiments, the techniques described herein relate to a method for detecting status of a trailer hitched to an autonomous electric tractor, including: receiving, at intervals, a motor current value from a drive circuit of the autonomous electric tractor; and determining that brakes of the trailer are applied when the motor current value reaches or exceeds a first current threshold.

In certain embodiments, the techniques described herein relate to a method for determining a trailer lifted status of a trailer hitched to a tractor, including: receiving input data including at least one of (a) images from a camera mounted on the tractor, (b) a point cloud from at least one LIDAR mounted on the tractor, and (c) radar data from at least one radar mounted on the tractor; and processing the input data through a neural network to generate the trailer lifted status indicative of whether a landing gear of the trailer as represented in the input data is lifted off a ground on which the trailer is positioned.

In certain embodiments, the techniques described herein relate to a method for detecting stall of an autonomous electric tractor, including: receiving, at intervals, a motor speed value of a sensed rotational speed of a drive motor of the autonomous electric tractor; and determining that the autonomous electric tractor is stalling based on the motor speed value.

In certain embodiments, the techniques described herein relate to a method for detecting stall of an autonomous electric tractor, including: receiving, at intervals, a vehicle speed value of the autonomous electric tractor; and determining that the autonomous electric tractor is stalling based on the vehicle speed value derived from one or more of (a) a global navigation satellite system of a location unit mounted to the autonomous electric tractor, an inertial navigation system of the location unit, and at least one wheel encoder that senses rotation of a wheel of the autonomous electric tractor.

In certain embodiments, the techniques described herein relate to a method for determining a trailer lifted status of a trailer hitched to a tractor, including: receiving, at intervals, a force value indicative of a force imparted by a trailer to a fifth-wheel of the tractor; and determining the trailer lifted status based on the force value.

In certain embodiments, the techniques described herein relate to a method for determining a trailer lifted status of a trailer hitched to a tractor, including: receiving, at intervals, a position value of a fifth-wheel of the tractor as it is raised to lift the trailer; and determining the trailer lifted status based on the position value.

### BRIEF DESCRIPTION OF THE FIGURES

FIG. 1 is an aerial view showing one example autonomous yard that uses an autonomous tractor to move trailers between a staging area and loading docks of a warehouse, in embodiments.

FIG. 2 is a block diagram illustrating key functional components of the tractor of FIG. 1, in embodiments.

FIG. 3 is a side elevation showing the tractor of FIG. 1 reversing under a lower surface of the trailer, in embodiments.

FIG. 4 shows example hitch and unhitch sequence of states implemented by a function state machine of FIG. 2, for coupling and uncoupling the tractor and the trailer, in embodiments.

FIG. 5 is a schematic plan view illustrating the tractor of FIGS. 1-3 backing the trailer up to one of a plurality of adjacent loading docks of the warehouse of FIG. 1, in embodiments.

FIG. 6 is a schematic showing example assumptions made by the tractor when determining a steering angle for controlling the tractor to reverse the trailer, in embodiments.

FIG. 7 is a block diagram illustrating the stall detector of FIG. 2 in further example detail, in embodiments.

FIG. 8 is a side elevation showing the tractor of FIGS. 1-3 attempting to reverse under a lower surface of the trailer, where the landing gear is not sufficiently extended, in embodiments.

FIG. 9 is a flowchart illustrating one example method for detecting and preventing stall of the drive motor of the tractor of FIGS. 1-3, in embodiments.

FIG. 10 shows the fifth-wheel (FW) of the tractor of FIGS. 1-3 lifting the front end of the trailer, in embodiments.

FIG. 11 shows the tractor of FIG. 10 coupled with the trailer and with the FW raised to provide the landing gear with a clearance above the ground, in embodiments.

FIG. 12 shows the FW controller and the FW actuator of the tractor of FIGS. 10 and 11 in further example detail, in embodiments.

FIG. 13 is a graph plotting a first derivative value against time, where a line represents a first derivative of pressure sensed by an upper pressure sensor as the FW actuator pumps hydraulic fluid into the hydraulic piston to raise the FW, in embodiments.

FIG. 14 is a graph plotting height against time, where a line represents height of the FW sensed by the position sensor of the FW actuator, in embodiments.

FIG. 15 is a flowchart illustrating one example method for sensing pressure values, calculating first derivative values, detecting a peak in the first derivative values, and lifting the trailer, in embodiments.

FIG. 16 is a block diagram illustrating the perception module of FIG. 2 in further example detail, in embodiments.

FIGS. 17A and 17B are a side perspective and a top perspective, respectively, of the tractor hitched to the trailer to illustrating example positioning of cameras, LIDARs, and/or radar on the tractor, in embodiments.

FIG. 18 also shows a camera positioned at the rear of the tractor to have a field of view beneath the trailer when hitched to tractor, in embodiments.

FIG. 19 is a block diagram illustrating the trailer brake monitor of FIG. 2 in further example detail, in embodiments.

FIG. 20 is a flowchart illustrating one example method for detecting a status of a trailer hitched to an autonomous electric tractor, in embodiments.

FIG. 21 is a block diagram illustrating the stall detector of FIG. 2 configured to monitor speed of the drive motor to detect motor stall, in embodiments.

FIG. 22 is a block diagram illustrating the stall detector of FIG. 2 configured to compare speed of the drive motor to a commanded motor speed to detect motor stall, in embodiments.

FIG. 23 is a block diagram illustrating the stall detector of FIG. 2 configured to detect motor stall based on a rate of change in speed of the drive motor, in embodiments.

FIG. 24 is a block diagram illustrating the stall detector of FIG. 2 configured to detect motor stall based on a proportional-integral-derivative function of the throttle controller, in embodiments.

FIG. 25 is a block diagram illustrating the stall detector of FIG. 2 configured to monitor speed of the tractor to detect motor stall, in embodiments.

### DETAILED DESCRIPTION OF THE EMBODIMENTS

In an automated yard, an autonomous tractor moves trailers between staging areas and loading docks for unloading and/or loading. The autonomous tractor repeatedly couples (hitches) to a trailer, moves the trailer, and then decouples (unhitches) from the trailer.

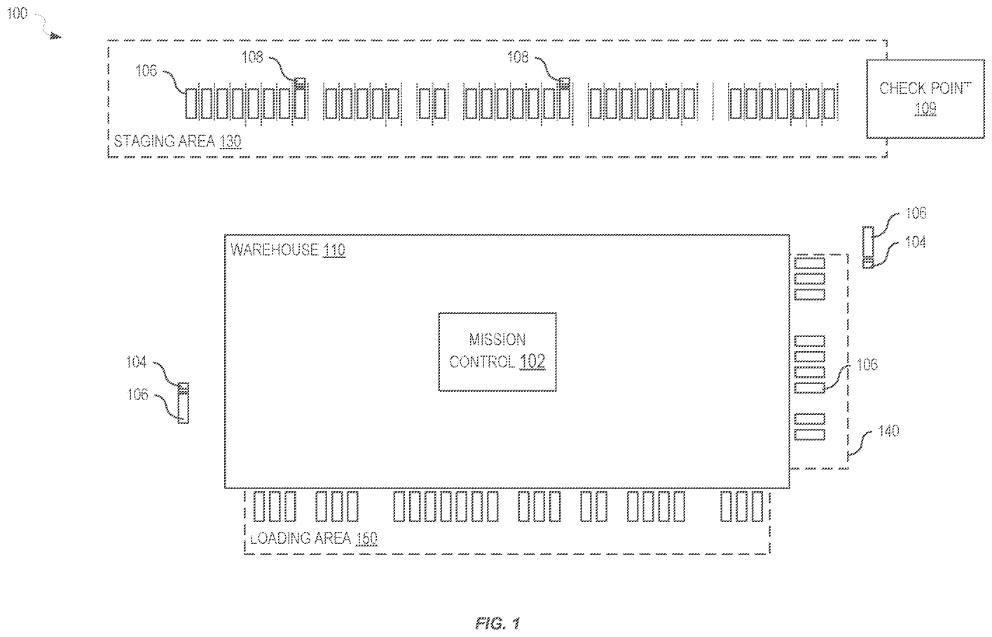

FIG. 1 is an aerial view showing one example autonomous yard 100 (e.g., a goods handling facility, shipping facility, etc.) that uses an autonomous electric tractor 104 to move trailers 106 between a staging area 130 and loading docks of a warehouse 110. For example, an over-the-road (OTR) tractors 108 deliver goods-laden trailers 106 from remote locations and retrieve trailers 106 for return to such locations (or elsewhere-such as a storage depot). In a standard operational procedure, OTR tractor 108 arrives with trailer 106 and checks-in at a facility entrance checkpoint 109. A guard/attendant enters information (e.g., trailer number or QR (ID) code scan-embedded information already in the system, which would typically include: trailer make/model/year/service connection location, etc.) into a mission control 102 (e.g., a computer software server that may be located offsite, in the cloud, fully onsite, or partially located within a facility building complex, shown as a warehouse 110). Warehouse 110 includes perimeter loading docks (located on one or more sides of the building), associated (typically elevated) cargo portals and doors, and floor storage, all arranged in a manner familiar to those of skill in shipping, logistics, and the like.

By way of a simplified operational example, after arrival of OTR tractor 108 and trailer 106, the guard/attendant at checkpoint 109 directs the driver to deliver trailer 106 to a specific numbered parking space in a designated staging area 130, which may include a large array of side-by-side trailer parking locations, arranged as appropriate for the facility's overall layout.

Once the driver has parked the trailer in the designated parking space of the staging area 130, he/she disconnects the service lines and ensures that connectors are in an accessible position (i.e. if adjustable/sealable), and decouples OTR tractor 108 from trailer 106. If trailer 106 is equipped with swing doors, this can also provide an opportunity for the driver to unlatch and clip trailer doors in the open position, if directed by yard personnel to do so.

At some later time, (e.g., when warehouse is ready to process the loaded trailer) mission control 102 directs (e.g., commands or otherwise controls) tractor 104 to automatically couple (e.g., hitch) with trailer 106 at a pick-up spot in staging area 130 and move trailer 106 to a drop-off spot at an assigned unloading dock in unloading area 140 for example. Accordingly, tractor 104 couples with trailer 106 at the pick-up spot, moves trailer 106 to unloading area 140, and then backs trailer 106 into the assigned loading dock at the drop-off spot such that the rear of trailer 106 is positioned in close proximity with the portal and cargo doors of warehouse 110. The pick-up spot and drop-off spot may be any designated trailer parking location in staging area 130, any loading dock in unloading area 140, and any loading dock within loading area 150.

Manual and/or automated techniques are used to offload the cargo from trailer 106 and into warehouse 110. During unloading, tractor 104 may remain hitched to trailer 106 or may decouple (e.g., unhitch) to perform other tasks. After unloading, mission control 102 directs tractor 104 to move trailer 106 from a pick-up spot in unloading area 140 and to a drop-off spot, either returning trailer 106 to staging area 130 or delivering trailer 106 to an assigned loading dock in a loading area 150 of warehouse 110, where trailer 106 is then loaded. Once loaded, mission control 102 directs tractor 104 to move trailer 106 from a pick-up spot in loading area 150 to a drop-off spot in staging area 130 where it may await collection by another (or the same) OTR tractor 108. Given the pick-up spot and the drop-off spot, tractor 104 may autonomously move trailer 106.

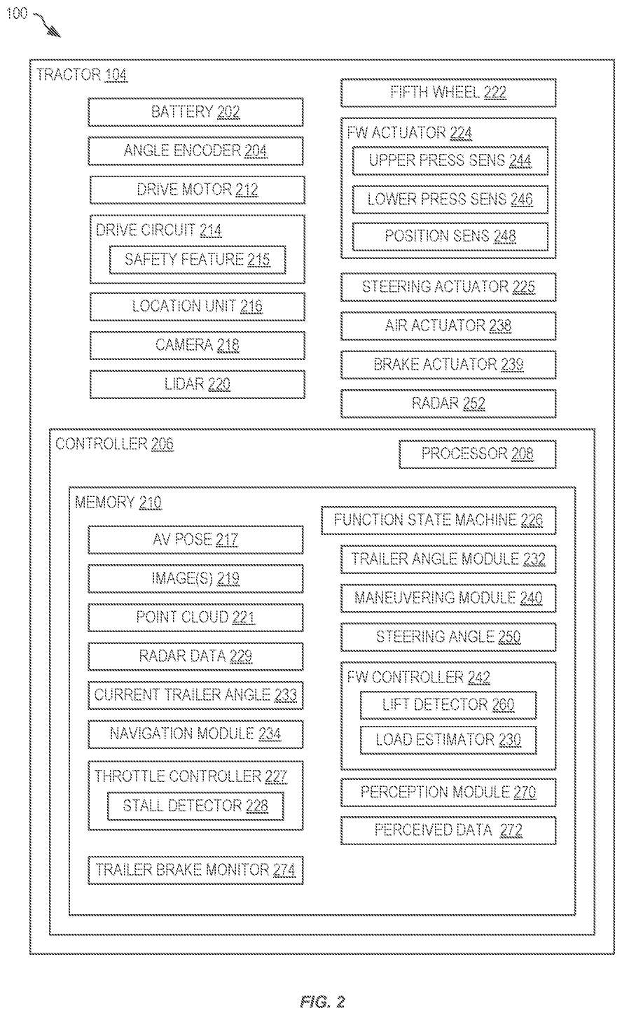

FIG. 2 is a block diagram illustrating key functional components of tractor 104 of FIG. 1. Tractor 104 includes a battery 202 for powering components of tractor 104 and a controller 206 with at least one digital processor 208 communicatively coupled with memory 210 that may include one or both of volatile memory (e.g., RAM, SRAM, etc.) and non-volatile memory (e.g., PROM, FLASH, Magnetic, Optical, etc.). Memory 210 stores a plurality of software modules including machine-readable instructions that, when executed by the at least one processor 208, cause the at least one processor 208 to implement functionality of tractor 104 as described herein to operate autonomously within autonomous yard 100 under direction from mission control 102.

Tractor 104 also includes at least one drive motor 212 controlled by a drive circuit 214 to mechanically drive a plurality of wheels (not shown) to maneuver tractor 104. Drive circuit 214 includes a safety feature 215 that deactivates motion of tractor 104 when it detects that rotation of drive motor 212 is impeded (e.g., stalled) and that drive motor 212 is drawing a current of six-hundred amperes, or more, for a predetermined period (e.g., five seconds). Safety feature 215 may thereby prevent damage to tractor 104 and/or other objects around tractor 104 when tractor 104 is impeded by an object. Safety feature 215 is described above with respect to an electric tractor. It should be appreciated that a similar safety feature could be included for diesel-based tractors, such as reducing engine power when an RPM threshold goes above a pre-set threshold. When safety feature 215 is tripped, tractor 104 requires manual reactivation before being able to resume movement. Accordingly, tripping safety feature 215 is undesirable.

Tractor 104 also includes a location unit 216 (e.g., a global navigation satellite system (GNSS) receiver such as global positioning system (GPS) and/or an inertial navigation system—INS) that determines an absolute location and orientation of tractor 104, a plurality of cameras 218 for capturing images 219 of objects and an environment around tractor 104, and at least one Light Detection and Ranging (LIDAR) device 220 (hereinafter LIDAR 220) for determining a point cloud about tractor 104. For example, the INS fuses GPS position with linear acceleration (accelerometers), rotational velocity (gyros) and/or dead reckoning (e.g., vehicle wheel encoders, etc) to determine a more accurate model of vehicle velocity that is resilient against single point failures, such as GPS signal drop out. For example, the INS may include MEMS accelerometers, MEMS gyros, laser ring gyros, and/or various kinds of electromechanical encoders that allow location unit 216 to accurately model and determine vehicle position and velocity estimates that are a mathematically optimal weighted combination of all available current sensor data and previously determined position and velocity estimates.

Location unit 216, the plurality of cameras 218, and the at least one LIDAR 220 cooperate with controller 206 to enable autonomous maneuverability and safety of tractor 104. Tractor 104 includes a fifth-wheel (FW) 222 for coupling with trailer 106 and a FW actuator 224 controlled by controller 206 to position FW 222 at a desired height. In certain embodiments, FW actuator 224 includes an electric motor coupled with a hydraulic pump that drives a hydraulic piston that moves FW 222. However, FW actuator 224 may include other devices for positioning FW 222 without departing from the scope hereof. Tractor 104 may also include an air actuator 238 that controls air supplied to trailer 106 and a brake actuator 239 that controls brakes of tractor 104 and trailer 106 when connected thereto via air actuator 238.

Controller 206 also includes a trailer angle module 232 that determines a current trailer angle 233 between tractor 104 and trailer 106 based on one or both of a trailer angle measured by an optical encoder 204 positioned near FW 222 and mechanically coupled with trailer 106 and a point cloud 221 captured by the at least one LIDAR 220. Controller 206 also uses at least one radar 252 to capture radar data 229 of objects and the environment around tractor 104.

Controller 206 also includes a throttle controller 227 that controls drive circuit 214 and includes a stall detector 228 that detects when drive motor 212 stalls. Controller 206 may also include FW controller 242 that implements a lift detector 260 for detecting when landing gear of trailer 106 is lifted off the ground, and a load estimator 230 for estimating the weight imparted by trailer 106 onto FW 222.

Controller 206 may implement a function state machine 226 that controls operation of tractor 104 based upon commands (requests) received from mission control 102. For example, mission control 102 may receive a request (e.g., via an API, and/or via a GUI used by a dispatch operator) to move trailer 106 from a first location (e.g., slot X in staging area 130) to a second location (e.g., loading dock Y in unloading area 140). Once this request is validated, mission control 102 invokes a mission planner (e.g., a software package, not shown) that computes a ‘mission plan’ for each tractor 104. For example, the mission plan is an ordered sequence of high-level primitives to be followed by tractor 104, in order to move trailer 106 from location X to location Y. The mission plan may include primitives such as drive along a first route, couple with trailer 106 in parking location X, drive along a second route, back trailer 106 into a loading dock, and decouple from trailer 106.

Function state machine 226 includes a plurality of states, each associated with at least one software routine (e.g., machine-readable instructions) that is executed by processor 208 to implements a particular function of tractor 104. Function state machine 226 may transitions through one or more states when following the primitives from mission control 102 to complete the mission plan.

Controller 206 may also include an articulated maneuvering module 240, implemented as machine-readable instructions that, when executed by processor 208, cause processor 208 to controls drive circuit 214 and steering actuator 225 to maneuver tractor 104 based on directives from mission control 102.

Controller 206 may also include a navigation module 234 that uses location unit 216 to determine an AV pose 217 that defines a current location and orientation of tractor 104. Navigation module 234 may also use other sensors (e.g., camera 218 and/or LIDAR 220) to determine AV pose 217, using dead-reckoning techniques for example.

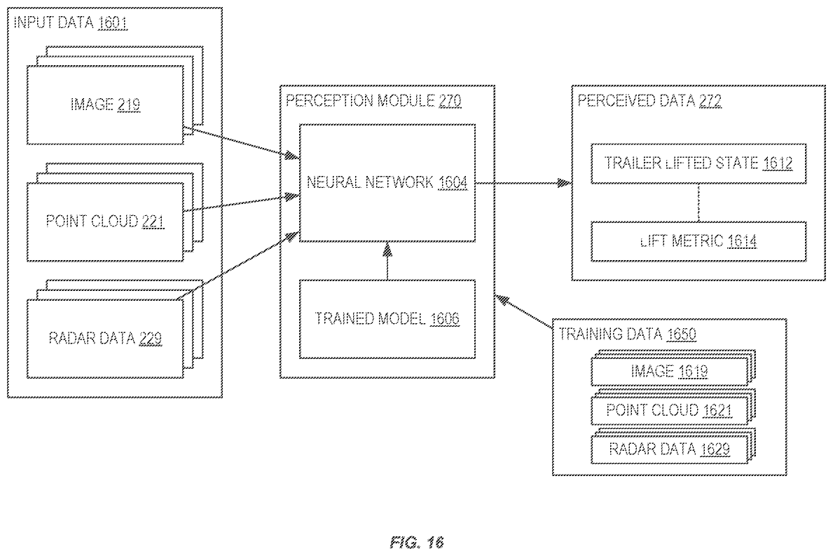

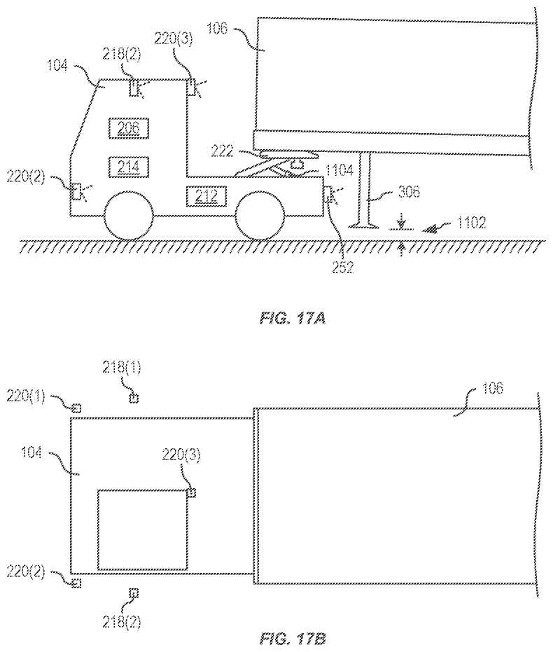

Controller 206 may also include a perception module 270 that generates perceived data 272 corresponding to a perceived environment of tractor 104. Perception module 270 is described in further detail below with reference to FIG. 16.

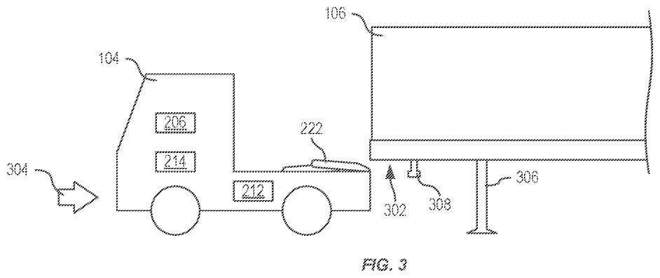

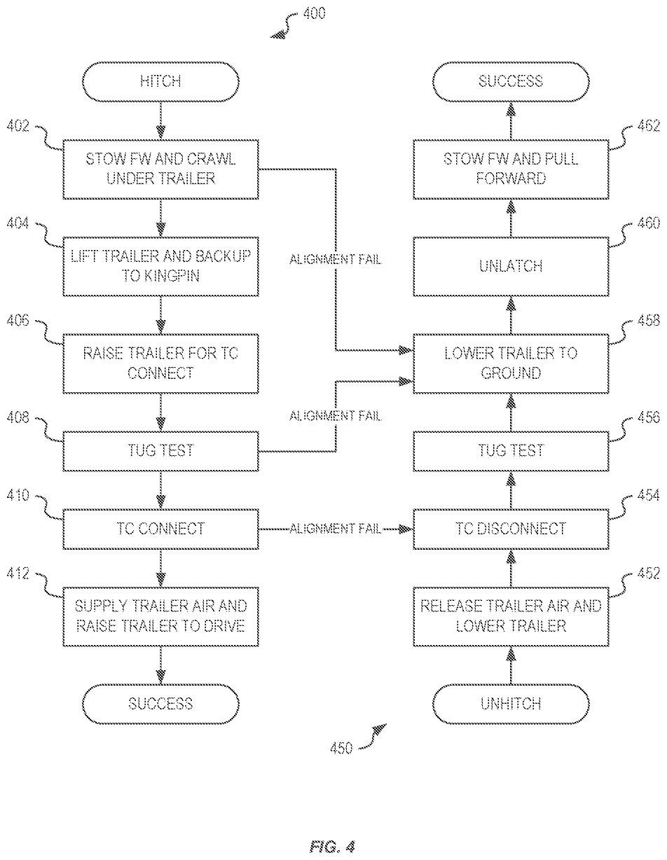

FIG. 3 is a side elevation showing tractor 104 of FIG. 1 reversing under a lower surface 302 of trailer 106. FIG. 4 shows one example hitch sequence 400 of states implemented by function state machine 226 of tractor 104, FIGS. 1-3, for coupling tractor 104 with trailer 106, and one example unhitch sequence 450 of states implemented by function state machine 226 for decoupling tractor 104 from trailer 106. FIG. 4 also shows example transitions between sequences when alignment fail is detected (e.g., when an activity of the current state fails for some reason), which allows function state machine 226 to recover from the failure (e.g., undo certain actions) and to reattempt the command. FIGS. 3 and 4 are best viewed together with the following description.

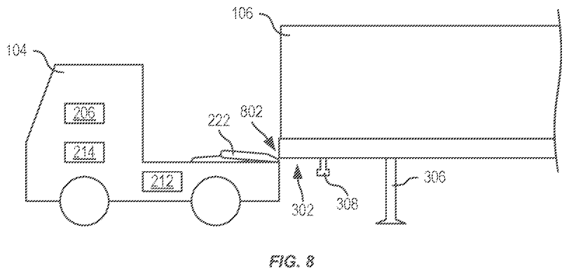

As shown in FIG. 3, landing gear 306 of trailer 106 is sufficiently extended such that a lower surface 302 (e.g., a FW plate) of a front end of trailer 106 is high enough above ground level to allow FW 222, when fully retracted, to be pushed thereunder without stalling drive motor 212 of tractor 104. That is, drive motor 212 provides sufficient force to push FW 222 under lower surface 302. However, landing gear 306 is extended by a driver of OTR tractor 108 when leaving trailer 106 in staging area 130 of autonomous yard 100, and therefore the height of lower surface 302 is at the discretion of the driver and may not be consistent between trailers 106. Further, the force required to move FW 222 under lower surface 302 is also dependent upon a weight (e.g., of goods) at the front end of trailer 106. When drive motor 212 is unable to provide sufficient force to push FW 222 beneath lower surface 302, such as when landing gear 306 is not sufficiently extended (see FIG. 8), drive motor 212 stalls.

In response to receiving a hitch command from mission control 102, once tractor 104 is aligned with trailer 106, controller 206, in state 402, stows FW 222 and controls drive circuit 214 to move tractor 104 slowly backwards as indicated by arrow 304. When controller 206 detects that FW 222 is beneath lower surface 302 of trailer 106, drive motor 212 is stopped and function state machine 226 transitions to state 404. If controller 206 determines that tractor 104 is not correctly aligned with trailer 106, function state machine 226 transitions to state 458 of unhitch sequence 450 such that another attempt may be made. In state 404, controller 206 controls FW actuator 224 to lift trailer 106 and controls drive circuit 214 to back tractor 104, and thus FW 222, up to a kingpin 308 of trailer 106. In state 406, controller 206 controls FW actuator 224 to raise FW 222 and thereby lift the front end of trailer 106 for Trailer Connect (e.g., a process of connecting air lines/electrical from tractor 104 to trailer 106 using gladhand ID and orientation). In state 408, controller 206 controls drive circuit 214 to perform a tug test. If controller 206 determines that tractor 104 is not correctly coupled with trailer 106 (e.g., the kingpin did not latch), function state machine 226 transitions to state 458 of unhitch sequence 450 such that another attempt may be made. In state 410, controller 206 controls trailer air actuator 238 to perform the TC connect. If controller 206 determines that the TC did not connect successfully, function state machine 226 transitions to state 454 of unhitch sequence 450 such that another attempt may be made. In state 412, controller 206 controls trailer air actuator 238 to supply trailer air and controls FW actuator 224 to raise FW 222 higher to ensure that the trailer landing gear clears the ground in preparation to drive.

In response to receiving an unhitch command from mission controller1 102, once trailer 106 is correctly positioned, controller 206, in state 452, controls trailer air actuator 238 to release trailer air and controls FW actuator 224 to lower FW 222 and the front end of trailer 106. In state 454, controller 206 controls trailer air actuator 238 to disconnect the TC from trailer 106. In state 456, controller 206 controls drive circuit 214 to move tractor 104 forward to perform a tug test. In state 458, controller 206 controls FW actuator 224 to lower the front end of trailer 106 to the ground. In state 460, controller 206 controls FW actuator 224 to unlatch from the trailer kingpin. In state 462, controller 206 controls FW actuator 224 to stow FW 222 and controls drive circuit 214 to cause tractor 104 to move forward away from trailer 106.

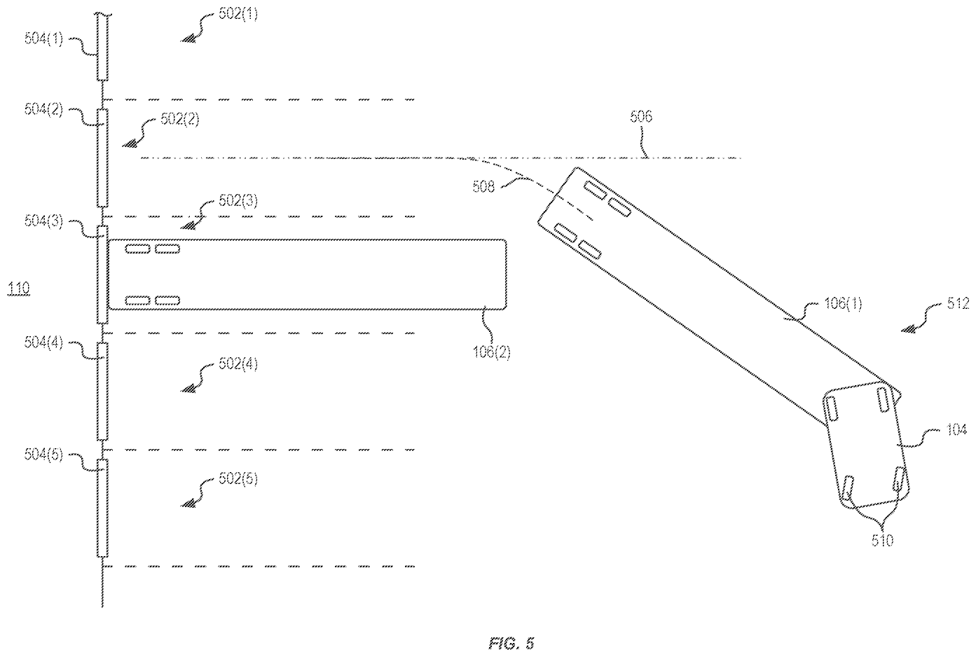

FIG. 5 is a schematic plan view illustrating tractor 104 backing trailer 106 up to one loading dock 502(2) of a plurality of adjacent loading docks 502(1)-(5) of warehouse 110. Tractor 104 coupled with trailer 106 may be referred to as vehicle 512. Each loading dock 502(1)-(5) has a corresponding loading door 504(1)-(5), and as shown, one trailer 106(2) is parked at loading dock 502(3). Since trailer doors are at the rear of trailer 106, trailer 106 is reversed up to loading dock 502 and is correctly aligned with loading door 504 to provide full and safe access to trailer 106. A reference path 506 may be defined for loading dock 502(2) to facilitate alignment of trailer 106(1) into loading dock 502(2). Maneuvering module 240 may predict a path 508 of trailer 106(1) when determining a steering angle 250 for steering wheels 510 of tractor 104.

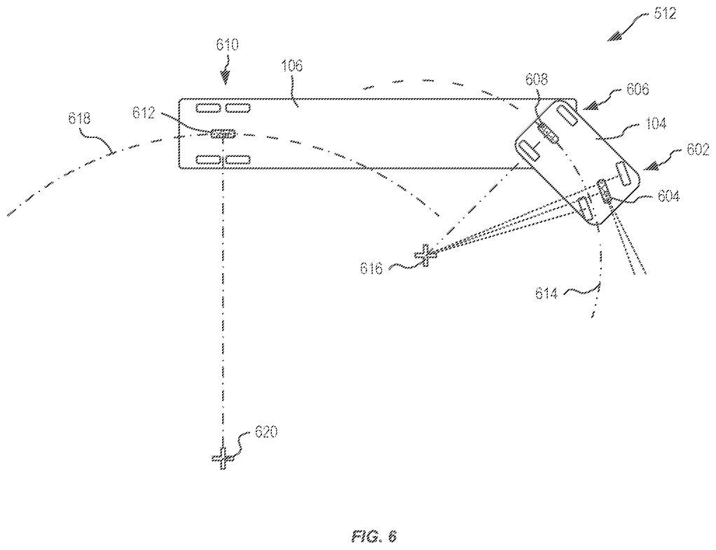

FIG. 6 is a schematic showing example assumptions made by maneuvering module 240 of tractor 104 when determining steering angle 250 for controlling tractor 104 to reverse trailer 106. For purposes of simplification, tractor 104 and trailer 106 are approximated in a kinematic bicycle model with nonholonomic constraints. A front axle 602 of tractor 104 is approximated by a single steerable modelled wheel 604 at the axle's center, a rear axle 606 of tractor 104 is approximated by a single non-steering modelled wheel 608 at the axle's center, and tandem 610 of trailer 106 is approximated as a single non-steering modelled wheel 612 centered in between both axles of tandem 610. This simplified representation of tractor 104 and trailer 106 allows any complex dynamic interactions between the actual wheels to be ignored and the nonholonomic constraint implies that none of the actual wheels move laterally. As shown in FIG. 6, tractor 104 is assumed to move along a circle 614 perpendicular to non-steering modelled wheel 608 about a tractor center of rotation 616, and trailer 106 is assumed to travel along a circle 618 perpendicular to non-steering modelled wheel 612 about a trailer center of rotation 620. This assumption is generally safe when tractor 104 and trailer 106 are moving at low speed (e.g., less than 15 miles-per-hour). Further assumptions include: tires do not deform, tires along an axle are properly aligned, and motion of the steering wheels of front axle 602 is approximated by the average angle the wheels.

However, to accurately back trailer 106 into loading dock 502(2), tractor 104 requires accurate knowledge of the position of the back end of trailer 106, and non-steering modelled wheel 612, relative to tractor 104.

### Motor Stall Prevention

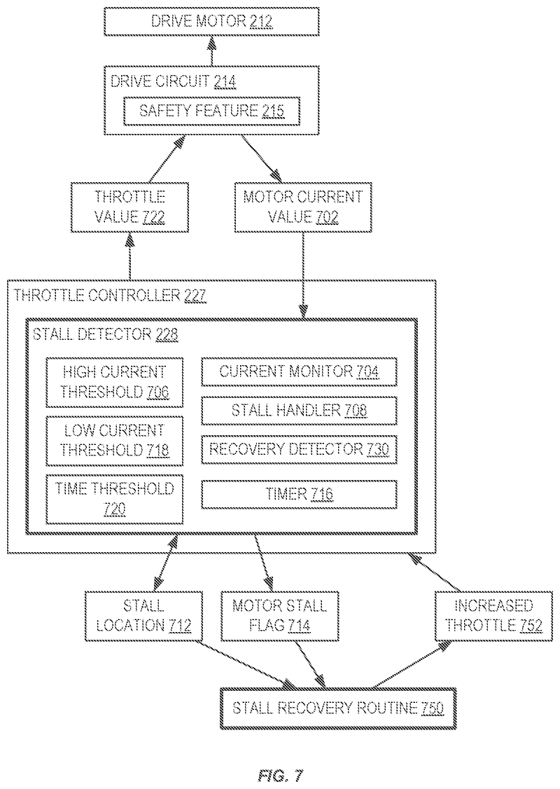

FIG. 7 is a block diagram illustrating stall detector 228 of FIG. 2 in further example detail, in embodiments. As noted above, deactivation of tractor 104 by safety feature 215 is undesirable, since a goal of autonomous yard 100 is to not require personnel movement within autonomous yard 100. Throttle controller 227 commands drive circuit 214 with a nominal throttle value 722 to maneuver tractor 104. For example, throttle controller 227 cycles at fifty hertz, determines a throttle value 722 based on requests from other modules (e.g., maneuvering module 240) and other factors (e.g., retry attempts, etc.), and sends throttle value 722 to drive circuit 214. However, certain maneuvers, such as coupling with a trailer, occasionally result in a stall of drive motor 212 when a height of landing gear 306 is insufficient to allow FW 222 of tractor 104 to slide under lower surface 302 of trailer 106. Accordingly, stall detector 228 operates to prevent safety feature 215 from being triggered. Advantageously, by detecting when drive motor 212 stalls, stall detector 228 provides additional status information that may be used by controller 206 to control movement of tractor 104. For example, when stall detector 228 detects drive motor 212 stalling while tractor 104 is coupling with trailer 106, the stall may indicate that tractor 104 is stuck at a front edge of trailer 106. In another example, when stall detector 228 detects drive motor 212 stalling while tractor 104 is reversing trailer 106 up to dock 502, the stall may indicate that the back end of trailer 106 is pressing against dock pads at dock 502. In another example, when stall detector 228 detects drive motor 212 stalling while tractor 104 is traversing an apron of autonomous yard 100 (e.g., when moving trailer 106 between staging area 130, unloading area 140, and loading area 150), the stall may indicate that tractor 104 and/or trailer 106 is blocked by an obstruction such as one or more of a lump of ice, dropped debris, a lip/curb/bunap/pothole in the pavement, and so on.

Using the coupling (hitching) function of tractor 104 with trailer 106 as an example, as shown in FIG. 3, when landing gear 306 of trailer 106 are sufficiently extended, a lower surface 302 (e.g., a FW plate) of trailer 106 is high enough above ground level to allow FW 222 of tractor 104 to be pushed thereunder without stalling drive motor 212. That is, at nominal throttle value 722, drive motor 212 provides sufficient force to push FW 222 under lower surface 302 to engage kingpin 308. However, landing gear 306 is extended by the driver of OTR tractor 108 when leaving trailer 106 in staging area 130 of autonomous yard 100, and therefore the height of lower surface 302 is at the discretion of the driver and may not be consistent between different trailers. Further, the force required to move FW 222 under lower surface 302 is also dependent upon the weight of goods carried by trailer 106, particularly as loaded at a front end of trailer 106.

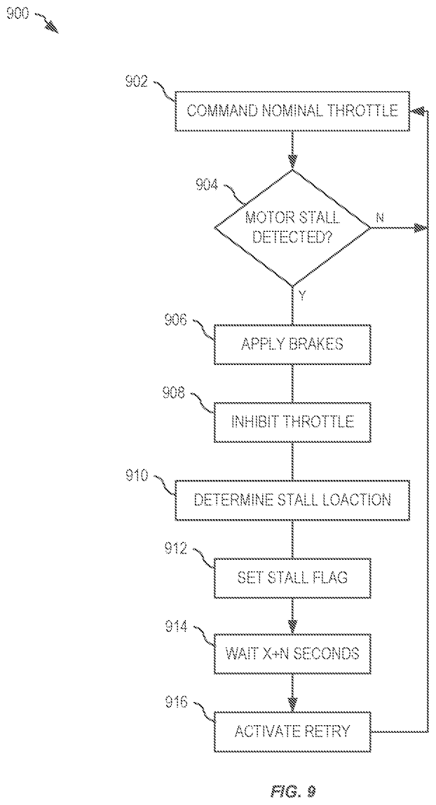

FIG. 8 is a side elevation showing tractor 104 attempting to reverse under lower surface 302 of a trailer 106, where landing gear 306 is not sufficiently extended, resulting in FW 222 getting stuck at a front edge 802 of trailer 106, and drive motor 212 stalling. FIG. 9 is a flowchart illustrating one example method 900 for detecting and preventing stall of drive motor 212 of tractor 104. Method 900 is implemented, at least in part, within stall detector 228 of FIG. 7. FIGS. 7, 8 and 9 are best viewed together with the following description.

Stall detector 228 receives, a motor current value 702 indicative of electrical current flowing through drive motor 212 from drive circuit 214 at intervals or substantially continuously. For example, motor current value 702 may be received from drive circuit 214 via a CAN bus of tractor 104. Stall detector 228 includes a current monitor 704 that compares motor current value 702 against a high current threshold 706 and determines that drive motor 212 is stalling when motor current value 702 is equal to, or greater than, high current threshold 706 for a predefined period (e.g., 4.5 seconds). When current monitor 704 determines that drive motor 212 is stalling, current monitor 704 invokes a stall handler 708, implemented as software, to initiate one or more actions for tractor 104 in response to the stall detection. In certain embodiments, stall handler 708 controls brake actuator 239 to apply brakes of tractor 104 and brakes of trailer 106 when coupled to tractor 104. Stall handler 708 also causes throttle controller 227 to request zero throttle, and effectively blocking other throttle inputs from being sent to drive circuit 214 and may determine a stall location 712 based on a current location of tractor 104 received from location unit 216 (e.g., GPS coordinates), and sets a motor stall flag 714. Stall handler 708 then restarts a timer 716 to allow drive motor 212 to cool down by inhibiting further throttle command of drive circuit 214 for at least a predefined time threshold 720. In certain embodiments, stall handler 708 may wait for current through drive motor 212 to drop below a low current threshold 718 before restarting timer 716.

Motor stall flag 714 may be evaluated by other software modules of controller 206, such that specific stall recovery actions may be taken in response to the detected motor stall. Accordingly, recovery from the detected motor stall is handled differently depending on a current state of function state machine 226 and the corresponding task being performed by tractor 104. For clarity of illustration, FIG. 7 shows a single stall recovery routine 750, which may represent any one or more of many context-specific stall recovery routines implemented by controller 206. In the following example, stall recovery routine 750 implements recovery from a detected stall of drive motor 212 when tractor 104 is attempting to couple (hitch) with trailer 106.

Stall recovery routine 750 initiates when motor stall flag 714 is cleared by stall detector 228, such as when timer 716 reaches time threshold 720. Stall recovery routine 750 may track and limit a number of retry attempts in response to the stall detection. For example, stall recovery routine 750 may limit attempts to drive tractor 104 beneath trailer 106 to three. Continuing with the above coupling example, stall recovery routine 750 first controls tractor 104 to move forward a predefined distance (e.g., two meters). Then stall recovery routine 750 attempts to drive FW 222 beneath front edge 802 of trailer 106 using an increased throttle 752. Stall recovery routine 750 may request increased throttle 752 with a value that is increased above the nominal throttle value for the maneuver by a factor corresponding to the retry attempt number. For example, stall recovery routine 750 may add 20% throttle to each retry attempt until a maximum throttle setting is attempted. That is, when stall detector 228 detects a motor stall on a retry attempt, the following retry attempt increases the throttle further. The increased throttle setting causes tractor 104 to move at a higher speed towards the object or problem causing the stall to overcome the obstacle or problem.

In certain embodiments, stall detector 228 includes a recovery detector 730 that detects when a retry attempt has succeeded and returns commands the throttle to the nominal throttle value for the maneuver. For example, recovery detector 730 may compare a current location of tractor 104 to stall location 712, determining that the retry attempt was successful when tractor 104 moves past stall location 712 based upon a current movement direction of tractor 104, and immediately command nominal throttle. Advantageously, recovery detector 730 prevents tractor 104 from continuing to move at a high speed once the reason for the stall is overcome.

In one example of operation, in block 902, method 900 commands a nominal throttle. In one example of block 902, controller 206 sends a throttle value 722 to drive circuit 214. Block 904 is a decision. If, in block 904, method 900 determines that a motor stall is detected, method 900 continues with block 906; otherwise, method 900 continues with block 902. In one example of block 904, current monitor 704 receives motor current value 702 from drive circuit 214 and compares it to high current threshold 706.

In block 906, method 900 applies brakes. In one example of block 906, stall handler 708 commands brake actuator 239 to apply brakes of tractor 104. In block 908, method 900 inhibits throttle. In one example of block 908, stall handler 708 causes throttle controller 227 to command zero throttle. In block 910, method 900 determines a stall location. In one example of block 910, stall handler 708 determines stall location 712 using location unit 216. In block 912, method 900 sets a stall flag. In one example of block 912, stall handler 708 sets motor stall flag 714. In block 914, method 900 waits X+N seconds. In one example of block 914, stall handler 708 starts timer 716 and waits until it reaches a time threshold 720. In block 916, method 900 activates retry. In one example of block 916, stall handler 708 clears motor stall flag 714 to initiate stall recovery routine 750.

### Lift Detection and Trailer Load Estimation

When tractor 104 is coupling (hitching) to trailer 106, it is important that FW 222 lifts trailer 106 before backing to kingpin. Tractor 104 uses FW 222 to lift the front end of trailer 106 to ensure that (a) FW 222 is aligned with kingpin 308 in the vertical direction (e.g., when FW 222 is in contact with the lower surface of trailer 106, FW 222 is vertically aligned to capture kingpin 308), and (b) that any force to trailer 106 on impact of FW 222 with kingpin 308 does not drag landing gear 306 over the ground (e.g., which may damage landing gear 306). For example, landing gear 306 may be set between 42 inches (1.067 m) and 51 inches (1.3 m) in height, however, the actual height is not measured.

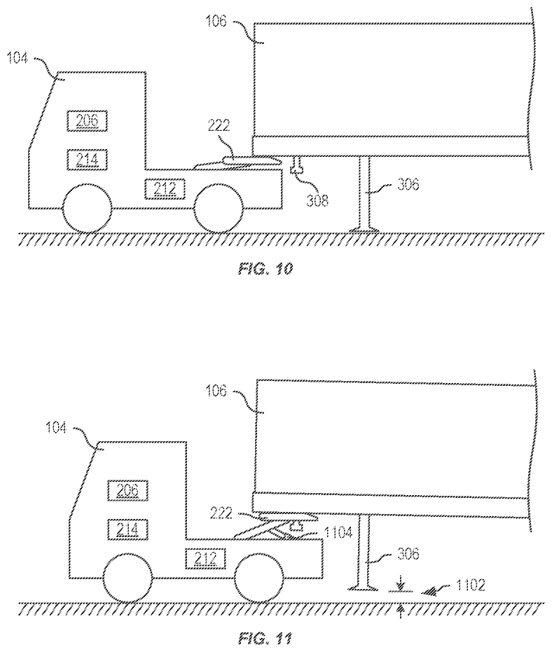

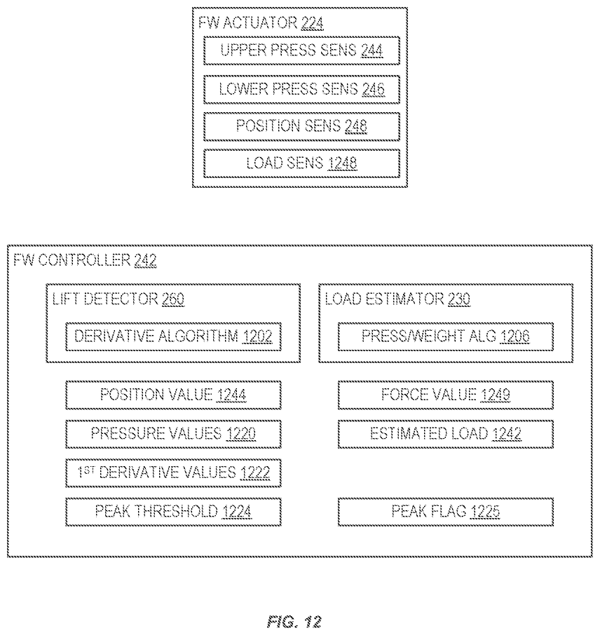

FIG. 10 shows FW 222 of tractor 104 lifting the front end of trailer 106 and aligning with the lower surface of trailer 106 and kingpin 308 prior to tractor 104 reversing to engage FW 222 with kingpin 308. FIG. 11 shows tractor 104 coupled with trailer 106 and with FW 222 raised to provide landing gear 306 with a clearance 1102 (e.g., six inches) above the ground. FIG. 12 shows the FW controller 242 and the FW actuator 224 of tractor 104 in further example detail. FIGS. 10-12 are best viewed together with the following description.

Since landing gear 306 is not retracted during maneuvering of trailer 106 by tractor 104, it is important that the front of trailer 106 is lifted such that clearance 1102 allows for variation in height of the ground being traversed by trailer 106. However, since the extension of landing gear 306 is not consistent, the height of FW 222 does not directly relate to clearance 1102. However, the front end of trailer 106 should not be lifted higher than needed, since (a) goods within trailer 106 may shift if the front end is lifted too high, and (b) lifting the front end of trailer 106 alters an angle formed at the back of trailer 106, which may prevent successful docking of trailer 106 at loading dock 502. Accordingly, it is useful to determine a height of FW 222 at which landing gear 306 lifts of the ground.

FW actuator 224 includes an upper pressure sensor 244 operable to measure a pressure in an upper chamber of a hydraulic piston 1104 that raises and lowers FW 222, and a position sensor 248 operable to provide feedback on a height of FW 222. FW actuator 224 may also include a lower pressure sensor 246 operable to measure a pressure in a lower chamber of the hydraulic piston. To raise FW 222, FW actuator 224 increases pressure (e.g., by pumping hydraulic fluid) in the upper chamber, and to lower FW 222, FW actuator 224 may increase pressure in the lower chamber and/or releasing pressure in the upper chamber. A differential between pressures measured by upper pressure sensor 244 and lower pressure sensor 246 may be used to estimate a force (e.g., a weight of the front end of trailer 106) pushing down onto FW 222.

To determine the height of landing gear 306 above the ground, lift detector 260 determines when landing gear 306 is initially lifted off the ground as FW 222 is raised. To detect when landing gear 306 is initially lifted off the ground, lift detector 260 calculates first derivative values 1222 (e.g., rate of change) of pressure values 1220 in the upper chamber as sensed by upper pressure sensor 244. A first rate of change in the sensed pressure is relatively constant prior to landing gear 306 leaving the ground (e.g., as FW 222 steadily increases a force applied to lift trailer 106). A second rate of change in the sensed pressure is relatively constant after landing gear 306 has left the ground (e.g., as FW 222 steadily lifts the front end of trailer 106). However, because the first rate of change is different from the second rate of change, as landing gear 306 lifts from the ground, the first derivative values 1222 peak. Lift detector 260 detects when first derivative values 1222 peak as landing gear 306 is lifted off the ground.

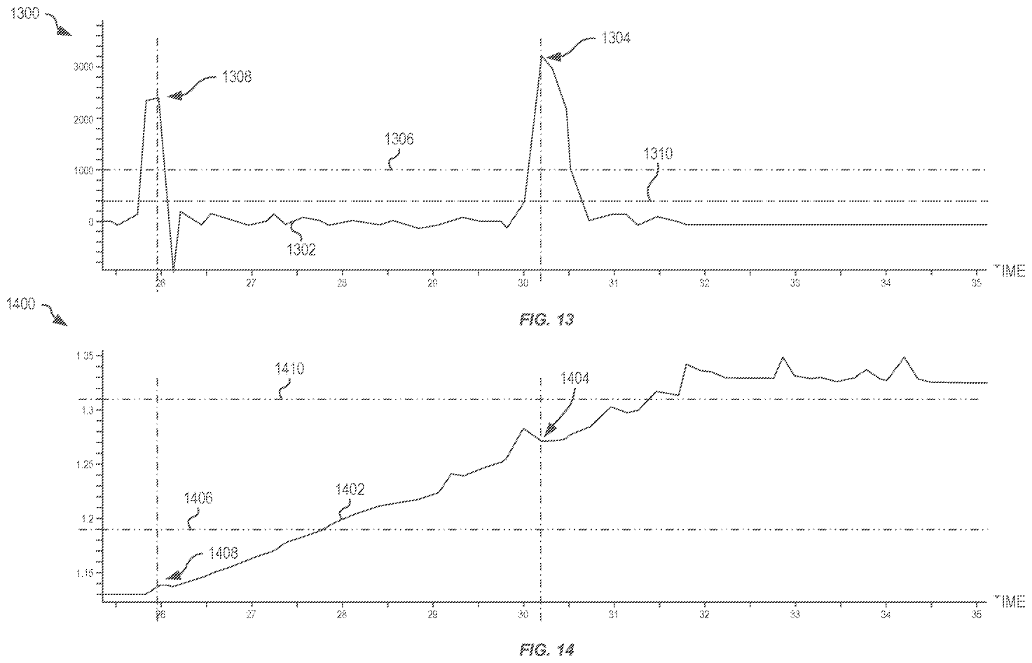

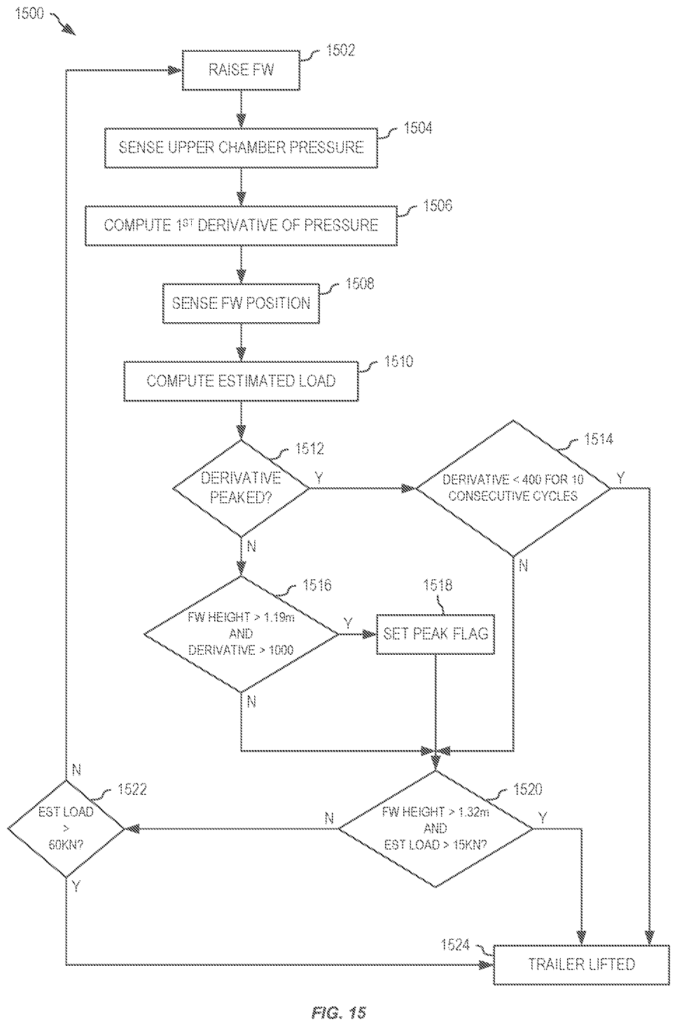

FIG. 13 is a graph 1300 plotting a first derivative value against time, where a line 1302 represents a first derivative of pressure sensed by upper pressure sensor 244 as FW actuator 224 pumps hydraulic fluid into the hydraulic piston to raise FW 222. FIG. 14 is a graph 1400 plotting height against time, where line 1402 represents height of FW 222 sensed by position sensor 248 of FW actuator 224. FIG. 15 is a flowchart illustrating one example method 1500 for sensing pressure values 1220, calculating first derivative values 1222, detecting a peak in first derivative values 1222, and determining a corresponding height of FW 222 to lift trailer 106. Method 1500 is implemented at least in part in load estimator 230 of controller 206 for example. FIGS. 12-15 are best viewed together with the following description.

In one example of operation, when trailer 106 is coupled with, or is coupling with, tractor 104 (e.g., FW 222 is at least positioned beneath a front end of trailer 106), controller 206 invokes lift detector 260 to lift trailer 106. In block 1502, method 1500 raises the FW. In one example of block 1502, lift detector 260 controls FW actuator 224 to raise FW 222. In block 1504, method 1500 senses the upper chamber pressure. In one example of block 1504, lift detector 260 reads a pressure value 1220 from upper pressure sensor 244. In block 1506, method 1500 computes a 1^{st} derivative of the pressure. In one example of block 1506, lift detector 260 uses derivative algorithm 1202 to determine 1^{st} derivative value 1222 from pressure value 1220. In block 1508, method 1500 senses a FW position. In one example of block 1508, lift detector 260 determines a current height of FW 222 by reading a position value 1244 from position sensor 248. In block 1510, method 1500 computes an estimated load. In one example of block 1510, lift detector 260 invokes load estimator 230 to calculate a load on FW 222 based on pressure value 1220, whereby load estimator 230 uses a pressure/weight algorithm 1206 to generate estimated load 1242 from pressure value 1220.

Block 1512 is a decision. If, in block 1512, method 1500 determines that the derivative has peaked, method 1500 continues with block 1514; otherwise method 1500 continues with block 1516. In one example of block 1512, lift detector 260 evaluates a peak flag 1225, initially cleared and set by block 1518, to determine whether a peak in 1^{st} derivative values 1222 has been detected. Block 1514 is a decision. If, in block 1514, method 1500 determines that the derivative value is less than a minimum derivative value (e.g., 400) for ten consecutive iterations, then method 1500 continues with block 1524; otherwise, method 1500 continues with block 1520. For example, after 1^{st} derivative values 1222 have peaked (e.g., peak flag is set) and reduce below a value of 400, indicated by line 1310, for ten consecutive cycles, then FW 222 is at a height that provides clearance 1102 between landing gear 306 and the ground. That is, the distance that FW 222 is raised during ten cycles of the loop in method 1500 corresponds to clearance 1102.

Block 1516 is a decision. If, in block 1516, method 1500 determines that height of the FW is greater than a minimum lift-off height (e.g., 1.19 m) and the 1^{st} derivative is greater than a minimum derivative peak threshold 1224 (e.g., 1000), then method 1500 continues with block 1518; otherwise method 1500 continues with block 1520. For example, as shown in FIGS. 13 and 14, when FW 222 initially moves at point 1408, 1s t derivative value 1222 exceeds the minimum derivative peak threshold 1224 indicated by line 1306 to form peak 1308. However, since the height of FW 222 is below the minimum lift-off height indicated by line 1406, this initial peak is ignored, and method 1500 proceeds with block 1520 without setting the peak flag. A subsequent peak 1304 in 1^{st} derivative value 1222 occurs when 1^{st} derivative value 1222 exceeds the minimum derivative peak threshold 1224 indicated by line 1306 and when the sensed height of FW 222 at corresponding point 1404 is above the minimum lift-off height indicated by line 1406, method 1500 proceeds with block 1518. In block 1518, method 1500 sets the peak flag. In one example of block 1518, lift detector 260 sets peak flag 1225, which is evaluated in block 1512.

Block 1520 is a decision. If, in block 1520, method 1500 determines that the height of the FW is greater than a maximum FW height threshold (e.g., 1.32 m) and the estimated load is greater than a minimum load threshold (e.g., 15 kN), then method 1500 continues with block 1524; otherwise method 1500 continues with block 1522. Block 1520 takes into account a scenario where trailer 106 is low (e.g., landing gear 306 is not sufficiently extended) such that FW 222 is already holding landing gear 306 off the ground when underneath, and therefore there is no significant change in 1^{st} derivative values 1222 as FW 222 is raised (e.g., since trailer 106 is already lifted). Block 1520 thereby detects when the height of FW 222 is above a maximum height threshold, indicated by line 1410 and when the estimated load (computed in block 1510) is above the minimum load threshold. Block 1522 is a decision. If, in block 1522, method 1500 determines that the estimated load is greater than a maximum load threshold (e.g., 60 kN), then method 1500 continues with block 1524; otherwise method 1500 continues with block 1502, and blocks 1502 through 1522 repeat. Block 1522 thereby addresses the scenario where FW 222 is carrying a load greater than 60 kN (e.g., a very heavy trailer) and the use of a maximum load threshold ensures that FW 222 is lifting, for a very heavy trailer, at least a minimum amount needed to relieve significant forces off landing gear 306. For example, when the maximum load threshold is reached, FW 222 is handling most of the weight of trailer 106, such that even if landing gear 306 appears to be still on the ground, landing gear 306 is not supporting any significant weight of trailer 106.

In block 1524, method 1500 determines that the trailer is lifted and stops raising FW 222. In one example of block 1524, lift detector 260 commands FW actuator 224 to stop raising FW 222. Method 1500 then terminates.

Blocks 1502 through 1522 of method 1500 form a loop that repeats to raise FW 222 and lift the front end of trailer 106, detecting when landing gear 306 leaves the ground, and then continuing to raise FW 222 for ten iterations of the loop such that landing gear 306 is raised a consistent height (e.g., clearance 1102) off the ground, irrespective of the extension of landing gear 306 and the starting height of the front end of trailer 106.

Although position sensor 248 does not directly provide the height of FW 222 above the ground, a calibration routine may be used such that lift detector 260 may convert position value 1244, read from position sensor 248, into a height of FW 222 above the ground. For example, FW actuator 224 is controlled to position FW 222 such that position sensor 248 reads zero (e.g., zero height) and the height of FW 222 above ground is measured. FW actuator 224 is then controlled to position FW 222 at its maximum height, the position sensor 248 is read, and the height of FW 222 above the ground is measured. Thus, values of position sensor 248 are known for the minimum and maximum positions of FW 222. The equation y=mx+c, is solved where y is the height of FW 222 above the ground, x is position sensor 248 value, and c is the zero height of FW 222. Then, the equation y=mx+c with the found value of m is used to determine the height of FW 222 for any read value from position sensor 248.

### Lift and Height Perception

As shown in FIG. 2, controller 206 may include perception module 270 that generates perceived data 272 defining a perceived environment of tractor 104. Advantageously, perception module 270 may be trained to detect whether trailer 106, hitched to tractor 104, is lifted from the ground for many different environments, in many different scenarios, and for many different trailer types and trailer lengths.

FIG. 16 is a block diagram illustrating perception module 270 of FIG. 2 in further example detail, in embodiments. FIGS. 17A and 17B are a side perspective and a top perspective, respectively, of tractor 104 hitched to trailer 106 to illustrating example positioning of cameras 218(1) and 218(2), LIDARs 220(1), 220(2), and 220(3), and/or radar 252 on tractor 104, in embodiments. FIGS. 16, 17A, and 17B are best viewed together with the following description.

Perception module 270 includes a neural network 1604 that uses a trained model 1606 to process an input data 1601, that includes one or more of images 219, point clouds 221, and radar data 229, to determine perceived data 272 that defines a trailer lifted status 1612 indicative of whether landing gear 306 has been lifted off the ground. Input data 1601 is captured by one or more of camera 218, LIDAR 220, and radar 252 of tractor 104, where camera 218, LIDAR 220, and radar 252 are configured in a fixed positional and orientational relationship with tractor 104 and where camera 218, LIDAR 220, and radar 252 have corresponding fields-of-view that include trailer 106 when hitched to tractor 104. In the example shown in FIGS. 17A and 17B, radar 252 is positioned to have a rearward field of view beneath trailer 106 when hitched to tractor 104. Advantageously, radar 252 captures radar data 229 that includes landing gear 306 when trailer 106 is hitched to tractor 104. In other embodiments, one or more cameras and or LIDARs may be similarly positioned to capture corresponding images 219 and point clouds 221 that include landing gear 306. As shown, LIDAR 220(3) is positioned to have a vantage point to detect lifting of trailer 106. LIDAR 220(3) could also be mounted on a mast or arm of tractor 104 to have an alternative vantage point. Similarly, LIDAR 220(3) could be positioned to have a field of view beneath trailer 106, such as at a location similar to radar 252. These specific vantage points may enhance the accuracy of perception module 270.

Trained model 1606 is generated using training data 1650 (e.g., multiple training sets) that includes a plurality of images 1619, a plurality of point clouds 1621, and a plurality of radar data 1629 that are annotated (e.g., tagged) to define a ground truth for operating neural network 1604 to determine one or both of trailer lifted state 1612 and lift metric 1614. Each trailing set uses contemporaneously captures information. Each trailing set may include at least one of an image, a point cloud, and radar data that are contemporaneously captured of the same trailer 106. For example, images 1619, point clouds 1621, and radar data 1629 are tagged with one or both of a corresponding trailer lifted status and/or a trailer height of landing gear 306 above the ground for the trailer captured in the images, point clouds, and radar data. Training data 1650 is generated using consistent positions of cameras 218, LIDARs 220, and radars 252 relative to tractor 104 such that trained model 1606 is generated for use with neural network 1604 on tractor 104 that has the same position and orientation of camera 218, LIDAR 220, and radar 252. For example, the cameras 218, LIDARs 220, and radar 252 may be mounted to structure of tractor 104 and/or mounted to bars, poles, or masts, whereby training data 1650 is captured using tractor 104 and annotated manually. Where multiple tractors are similarly configured, training data 1650 may be captured using these multiple tractors and associated perception modules thereon.

Preferably, the training data is captured from collections of different trailers, including different types and lengths of trailer, and for varying heights of landing gear 306 above the ground. Trained model 1606 is preferably generated using a large volume of training data. For example, the training set includes images 219, point clouds 221, and radar data 229 collected from at least one tractor 104 operating in multiple yards and under various use cases and various environmental conditions, where trailers are in different parking spots (e.g., within staging area 130 and at loading docks of loading area 150). Particularly, the training data (e.g., images 219, point clouds 221, and radar data 229) is collected in weather conditions and at sites that are relevant to expected operation of perception module 270 (e.g., for a particular the business case). Where multiple tractors 104 are used, these tractors are configured with camera 218, LIDARs 220, and radars 252, at the same position and orientation relative to the vehicle such that the captured training set is consistent. Depending upon the position of camera 218, LIDAR 220, and radar 252 on tractor 104, the training data may or may not include explicit data for landing gear 306, and may define a value for lift metric 1614 (e.g., height of landing gear 306 above the ground), and other measurable characteristics useful for the application. The training set is then used to train neural network 1604 and generate trained model 1606 for use during operation of perception module 270.

In certain embodiments, perception module 270 runs as a service that is activated and deactivated by controller 206. When activated, perception module 270 autonomously determines trailer lifted state 1612 of hitched trailer 106 captured within images 219, point cloud 221, and radar data 229. That is, perception module 270 receives current (e.g., real-time) images 219, point cloud 221, and radar data 229 from cameras 218, LIDARs 220, and radars 252 of tractor 104. Perception module 270 processes input data 1601 and generates perceived data 272 that includes a trailer lifted state 1612 defining whether, or not, landing gear 306 of trailer 106 is lifted off the ground (e.g., when FW 222 is raised). Perceived data 272 may also include a lift metric 1614 that indicates a height of landing gear 306 above the ground as perceived by perception module 270.

In one operational example, after hitching to, and lifting, trailer 106, controller 206 activates perception module 270 to process input data 1601 that includes at least one of image 219, point cloud 221, and radar data 229 to generate trailer lifted state 1612 and/or lift metric 1614. Advantageously, controller 206 learns from perceived data 272 whether landing gear 306 was successfully lifted off the ground prior to moving trailer 106. In certain circumstances where controller 206 is made aware of required clearance 1102 for a given mission received from mission control 102, such as when additional clearance of landing gear 306 above the ground is required for a portion of autonomous yard 100, controller 206 may evaluate lift metric 1614 to determine whether clearance 1102 is met, and increases the height of FW 222 as needed. Similarly, controller 206 may lower FW 222 when lift metric 1614 indicates trailer 106 is lifted too high.

### Alternative Embodiments for Trailer Lift Detection

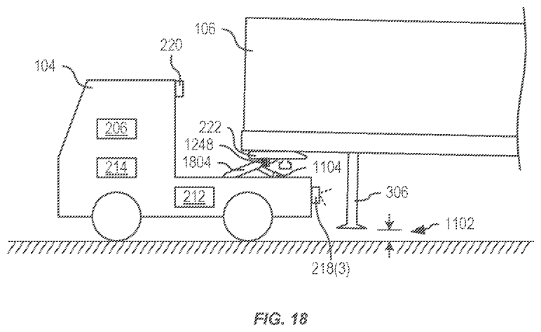

FIG. 18 a side perspective of tractor 104 hitched to trailer 106 to illustrating example positioning of a load sensor 1248 (see FIG. 12) on a boom 1804 of FW 222 for detecting a load of trailer 106, in embodiments. Load sensor 1248 may be part of FW actuator 224. Load sensor 1248 is positioned at to detect a downward force imparted by trailer 106 onto FW 222. In certain embodiments, load sensor 1248 is a strain-gauge positioned on a boom of FW 222. In other embodiments, load sensor 1248 is a load cell.

Controller 206 reads load sensor 1248 to determine a force value 1249 (see FIG. 12) imparted by trailer 106 and may use force value 1249 to estimate a weight of trailer 106. As FW 222 is raised to lift trailer 106, the force detected by load sensor 1248 increases until landing gear 306 lifts off the ground and FW 222 carries the weight of the front of trailer 106. Accordingly, similar to method 1500 of FIG. 15, lift detector 260 may monitor force value 1249 (e.g., output of load sensor 1248) to determine a point as which landing gear 306 lifts of the ground as the point when the force sensed by load sensor 1248 indicates a significant reduction in its rate of increase.

FIG. 18 also shows a camera 218(3) positioned at the rear of tractor 104 to have a field of view beneath trailer 106 when hitched to tractor 104. Camera 218(3) may be replaced by a LIDAR or a radar to capture data relating to landing gear 306 as trailer 106 is lifted by FW 222. In this example, lift detector 260 processes images 219 from camera 218(3) as FW 222 is raised to detect when landing gear 306 lifts of the ground. For example, lift detector 260 may process images 219 from camera 218(3) using image recognition to measure a clearance of landing gear 306 from the ground. Similar process may be performed from point cloud 221 and radar data 229 when available. For example, lift detector 260 may detect when landing gear 306 separates from a ground plane formed by the ground on which trailer 106 is standing. Alternately, lift detector 260 may process images 219 to detect the ground plane and a plane forming a bottom surface of trailer 106. Then, lift detector 260 calculates a distance between the two planes to determine when the distance increases, indicating that the trailer is lifting off the ground. Accordingly, a direct measurement of a height of landing gear 306 of the ground is determined from one or more of images 219, point cloud 221, and radar data 229.

In another example, similar to method 1500 of FIG. 15, lift detector 260 detects when landing gear 306 leaves the ground based on position value 1244 (e.g., see line 1402 of FIG. 14) read from position sensor 248 as FW 222 is raised. In this example, lift detector 260 determines a first derivative of the position value 1244 and determines that FW 222 contacts and starts lifting trailer 106 when the first derivative is below a negative threshold. This negative threshold indicates that movement of FW 222 is slowing as a result of the weight of trailer 106 being lifted by FW 222. Based on position value 1244 (e.g., height of FW 222) at the detected negative peak in this first differential, lift detector 260 may estimate, based on time and/or position value 1244, when landing gear 306 lifts of the ground as FW 222 continues to rise.

Lift detector 260 may implement any combination of these ways of detecting when landing gear 306 leaves the ground.

### Detecting Trailer Brakes

In certain embodiments, controller 206 includes a trailer brake monitor 274 that determines when a trailer being towed by tractor 104 has its brakes applied. That is, when 106 is unable to release brakes of trailer 106, depending on loading of the trailer, tractor 104 may or may not be able to move trailer 106.

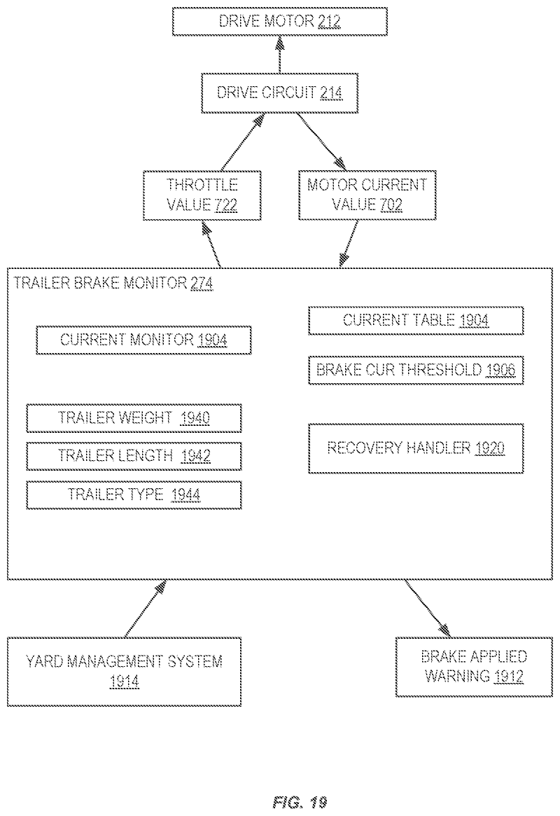

FIG. 19 is a block diagram illustrating trailer brake monitor 274 of FIG. 2 in further example detail, in embodiments. Trailer brake monitor 274 is implemented as software within controller 206. In certain embodiments, trailer brake monitor 274 is part of throttle controller 227.

Throttle controller 227 commands drive circuit 214 with a nominal throttle value 722 to cause tractor 104 to move trailer 106. However, when brakes of trailer 106 are applied, drive motor 212 draws more current as compared to when brakes of trailer 106 are not applied. Trailer brake monitor 274 monitors motor current value 702 of drive circuit 214 to determine when motor current value 702 equals or exceeds a brake current threshold 1906. Advantageously, by detecting when drive motor 212 uses more than an expected amount of current for the type, length, and/or weight of trailer 106, trailer brake monitor 274 determines that brakes of trailer 106 may be applied and inhibits operation of throttle controller 227 and/or commands zero throttle to prevent damage to tractor 104 and/or trailer 106. Trailer brake monitor 274 may also generate a brake applied warning 1912 that notifies an operator of the anomaly.

Trailer brake monitor 274 may include a current table 1904 that defines a maximum expected current draw by drive motor 212 for a given weight, length, and type of trailer 106. Drive motor 212 is expected to draw more current when moving a loaded trailer as compared to when moving the same trailer when empty. Similarly, drive motor 212 is expected to draw more current when moving a long trailer as compared to when moving a short trailer, and drive motor 212 is expected to draw different amount of current for different trailer type. Accordingly, trailer brake monitor 274 determines at least one of a trailer weight 1940, a trailer length 1942, and a trailer type 1944 for trailer 106 hitched to tractor 104.

In certain embodiments, trailer brake monitor 274 retrieves one or more of trailer weight 1940, trailer length 1942, and trailer type 1944 from a Yard Management System (YMS) 1914 of autonomous yard 100. YMS 1914 is for example a software program and database that tracks inventory of trailers 106 within autonomous yard 100. YMS 1914 may be a component of mission control 102 discussed herein, or may be in communication with mission control 102 such as via an API interface. Accordingly, Y M S 1914 defines a status of each trailer, including its weight, its length, and its type. Advantageously, trailer brake monitor 274 may retrieve this information from YMS 1914 (e.g., via mission control 102) as trailer weight 1940, trailer length 1942, and trailer type 1944. In another example, trailer brake monitor 274 determines trailer weight 1940, trailer length 1942, and trailer type 1944 from perceived data 272 generated by perception module 270. For example, perception module 270 may include a trained model (e.g., similar to trained model 1606 of FIG. 16) that allows neural network 1604 to determine trailer weight 1940, trailer length 1942, and trailer type 1944 from input data 1601. In another example, as described above, load estimator 230 uses pressure/weight algorithm 1206 to generate estimated load 1242 from pressure value 1220 of FW actuator 224, whereby trailer brake monitor 274 estimates trailer weight 1940 based on estimated load 1242 (e.g., using a formula or a lookup table based on trailer type and length for example.

Trailer brake monitor 274 may also include a recovery handler 1920 that is invoked when trailer brake monitor 274 determines that brakes of trailer 106 are applied when tractor 104 is attempting to move trailer 106. Recovery handler 1920 implements at least one set of actions when trailer brake monitor 274 determines that the brakes are applied. For example, recovery handler 1920 may initiate a first set of actions that autonomously disconnect the gladhand from trailer 106, then reconnect the gladhand to trailer 106, and then reattempt to move trailer 106. Alternatively, or when the first set of actions is unsuccessful, recovery handler 1920 may initiate a second set of actions that request and then await remote assistance. Alternatively, or when the first or second set of actions is unsuccessful, recovery handler 1920 may initiate a third set of actions that autonomously unhitch tractor 104 from trailer 106, report the failure to move trailer 106 to mission control 102, and then request an additional mission, which may be implemented immediately, or added to a queue of missions to be performed by the autonomous electric tractor 104.

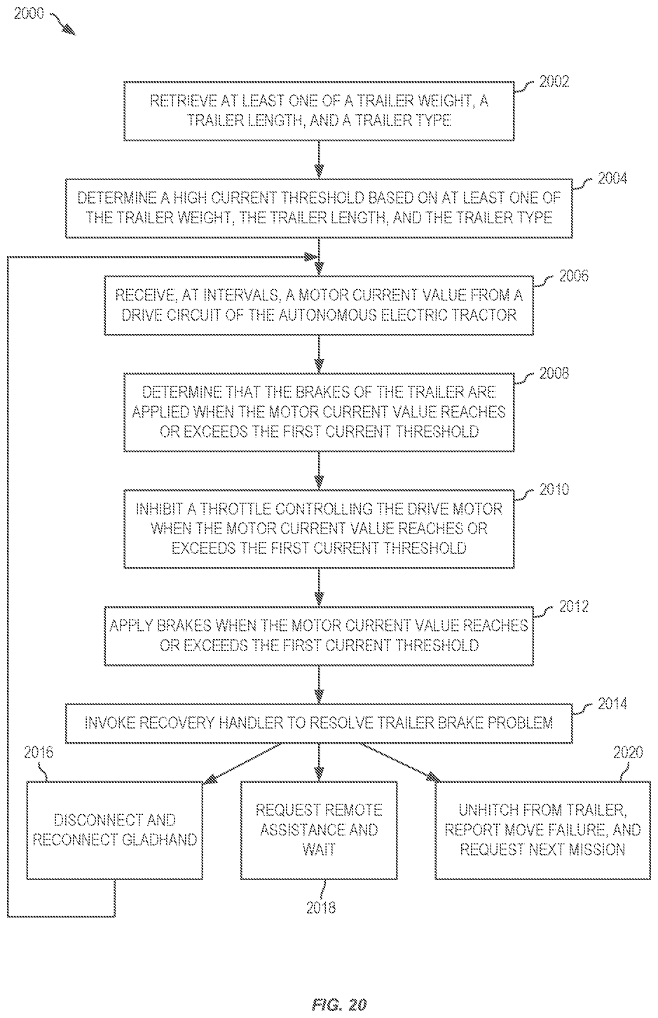

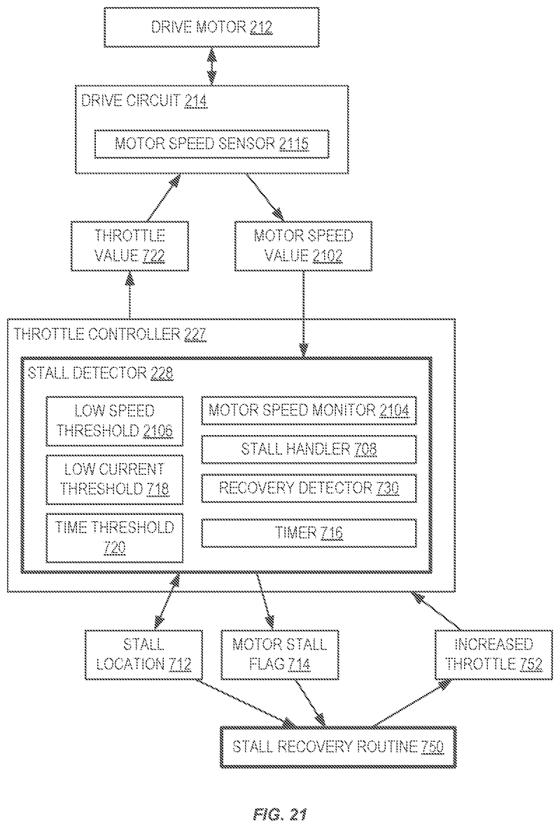

FIG. 20 is a flowchart illustrating one example method 2000 for detecting a status of a trailer hitched to an autonomous electric tractor, in embodiments. Method 2000 is implemented in trailer brake monitor 274 of controller 206, for example.

In block 2002, method 2000 retrieves at least one of a trailer weight, a trailer length, and a trailer type. In one example of block 2002, trailer brake monitor 274 retrieves trailer weight 1940, trailer length 1942, and trailer type 1944 from YMS 1914. In another example of block 2002, trailer brake monitor 274 determines trailer weight 1940 based on estimated load 1242 on FW 222 of tractor 104 when a front of trailer 106 is lifted by FW 222.

In block 2004, method 2000 determines a first current threshold based on at least one of the trailer weight, the trailer length, and the trailer type. In one example of block 2004, trailer brake monitor 274 determines brake current threshold 1906 from current table 1904 based on trailer weight 1940.

In block 2006, method 2000 receives, at intervals, a motor current value from a drive circuit of the autonomous electric tractor. In one example of block 2006, trailer brake monitor 274 receives motor current value 702 from drive circuit 214.

In block 2008, method 2000 determines that the brakes of the trailer are applied when the motor current value reaches or exceeds the first current threshold. In one example of block 2008, trailer brake monitor 274 determines that the brakes of trailer 106 are applied when motor current value 702 equals or exceeds brake current threshold 1906. For example, prior to moving trailer 106, controller 206 commands brake actuator 239 and/or air actuator 238 to release brakes of tractor 104 and trailer 106. However, in certain cases the brakes of trailer 106 may fail to release, such as when the trailer brake mechanism is stuck, when the air supply is incorrectly connected, or when another fault occurs.

In block 2010, method 2000 inhibits a throttle controlling the drive motor when the motor current value reaches or exceeds the first current threshold. In one example of block 2010, when motor current value 702 equals or exceeds brake current threshold 1906, trailer brake monitor 274 inhibits further throttle command of drive circuit 214.

In block 2012, method 2000 applies brakes when the motor current value reaches or exceeds the first current threshold. In one example of block 2012, trailer brake monitor 274 commands brake actuator 239 and/or air actuator 238 to apply brakes of tractor 104 and/or trailer 106. Although the trailer brakes are still applied (e.g., failed to release), trailer brake monitor 274 commands air actuator 238 to apply brakes of trailer 106.

In block 2014, method 2000 invokes a recovery handler to resolve the trailer brake problem. In one example of block 2014, current table 1904 invokes recovery handler 1920 to implement at least one set of actions, and may cause tractor 104 to retry the trailer move and invoke other actions as needed.

In block 2016, method 2000 disconnects and reconnects the gladhand. In one example of block 2016, recovery handler 1920 causes tractor 104 to disconnect its gladhand from trailer 106, then to reconnect its gladhand to trailer 106, and then to retry the trailer move.

In block 2018, method 2000 requests remote assistance and then waits. In one example of block 2018, recovery handler 1920 interacts with mission control 102 to request remote assistance and then waits for further instructions.

In block 2020, method 2000 unhitches the tractor from the trailer, reports the move failure to mission control and requests a next mission. In one example of block 2020, recovery handler 1920 causes tractor 104 to unhitch from trailer 106 (e.g., lowering trailer 106 onto its landing gear, disconnecting its gladhand from trailer 106, causing FW 222 to release the kingpin of trailer 106, causing tractor 104 to pull away from trailer 106, and then interacting with mission control 102 to indicate failure of the move and to request an additional mission, which may be implemented immediately, or added to a queue of missions to be performed by the autonomous electric tractor 104.

### Alternative Embodiments for Motor Stall Detection

In the above embodiments, current drawn by drive motor 212 is used to detect when motor stall occurs. However, other methods of detecting motor stall may be used.

FIG. 21 is a block diagram illustrating stall detector 228 of FIG. 2 configured to monitor speed of drive motor 212 to detect motor stall, in embodiments. Stall detector 228 operates as described above with respect to FIG. 7, but includes a motor speed monitor 2104 that receives a motor speed value 2102 from a motor speed sensor 2115 of drive circuit 214. Motor speed sensor 2115 senses a rotational speed of drive motor 212 and sends a corresponding motor speed value 2102 to throttle controller 227. For example, motor speed sensor 2115 may be attached to, or embedded with, drive motor 212 to sense rotational speed. Motor speed monitor 2104 determines that drive motor 212 has stalled when motor speed value 2102 drops below a low speed threshold 2106 that defines a minimum expected speed of drive motor 212 for a particular operation. When the motor stall is detected, motor speed monitor 2104 initiates stall handler 708, which operates as described above.

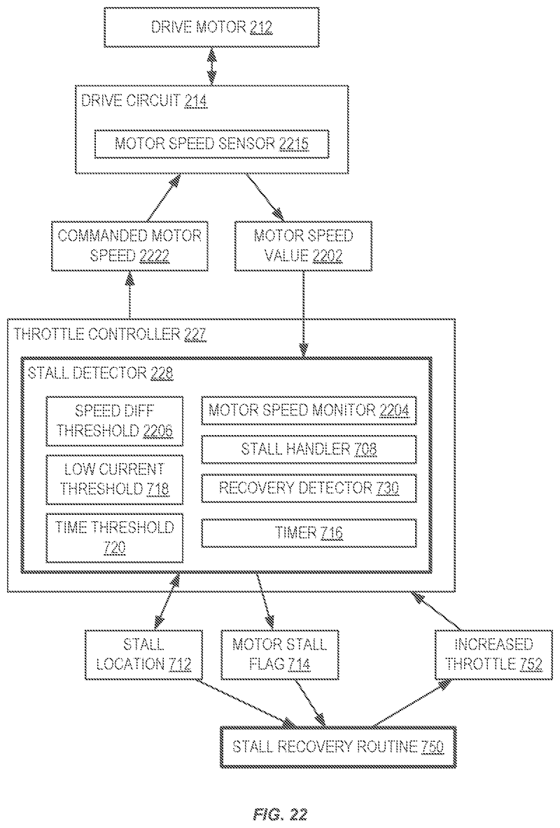

FIG. 22 is a block diagram illustrating stall detector 228 of FIG. 2 configured to compare speed of drive motor 212 to a commanded motor speed 2222 to detect motor stall, in embodiments. Stall detector 228 operates as described above with respect to FIG. 7, but includes a motor speed monitor 2204 that receives a motor speed value 2202 from a motor speed sensor 2215 of drive circuit 214. Motor speed sensor 2215 senses a rotational speed of drive motor 212 and sends a corresponding motor speed value 2202 to throttle controller 227. In this embodiments, throttle controller 227 sends a commanded motor speed 2222 to drive circuit 214, which drives drive motor 212. Motor speed monitor 2204 determines that drive motor 212 has stalled when a difference between commanded motor speed 2222 and motor speed value 2202 is greater than a speed differential threshold 2206, which defines a maximum speed difference between commanded motor speed 2222 and motor speed value 2202 that is expected for a particular operation. When the motor stall is detected, motor speed monitor 2204 initiates stall handler 708, which operates as described above.

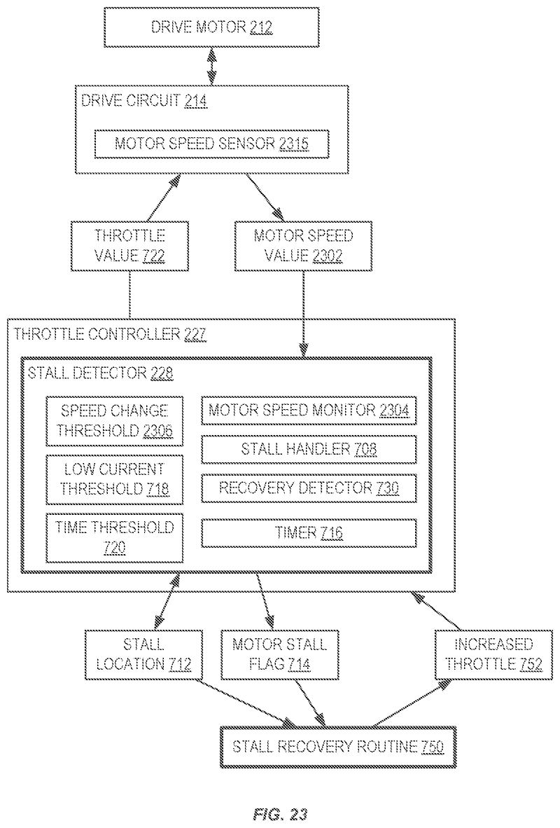

FIG. 23 is a block diagram illustrating stall detector 228 of FIG. 2 configured to detect motor stall based on a rate of change in speed of drive motor 212, in embodiments. Stall detector 228 operates as described above with respect to FIG. 7, but includes a motor speed monitor 2304 that receives a motor speed value 2302 from a motor speed sensor 2315 of drive circuit 214. Motor speed sensor 2315 senses a rotational speed of drive motor 212 and sends a corresponding motor speed value 2302 to throttle controller 227. Motor speed monitor 2304 determines a first derivative of received motor speed value 2302 and determines that drive motor 212 has stalled when the first derivative is below a speed change threshold 2306, which defines a negative threshold that is indicative of drive motor 212 reducing speed at a rate indicative of a motor stall for a particular operation. When the motor stall is detected, motor speed monitor 2304 initiates stall handler 708, which operates as described above.

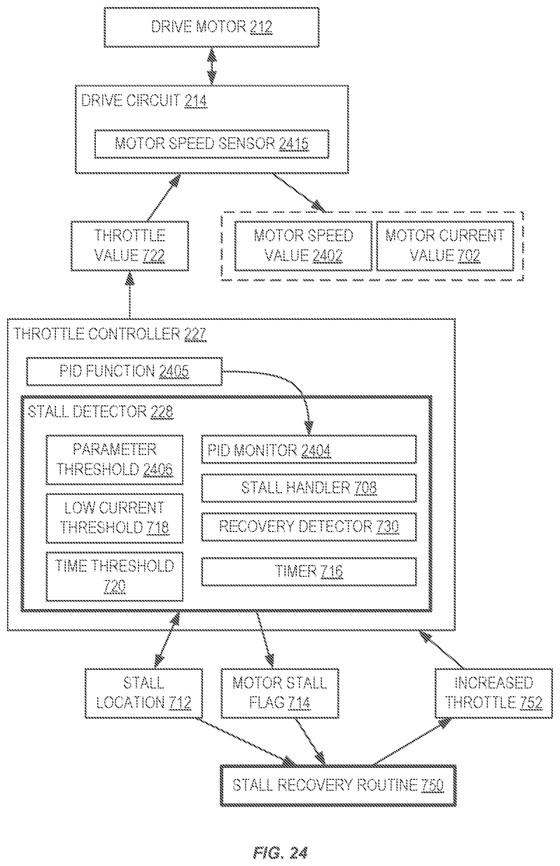

FIG. 24 is a block diagram illustrating stall detector 228 of FIG. 2 configured to detect motor stall based on a proportional-integral-derivative (PID) function 2405 of throttle controller 227, in embodiments. In this embodiments, throttle controller 227 uses PID function 2405 to command throttle value 722 of drive circuit 214 based on one or both of motor current value 702 and a motor speed value 2402 from a motor speed sensor 2415 of drive circuit 214. Stall detector 228 operates as described above with respect to FIG. 7, but includes a PID monitor 2404 that compares parameters of PID function 2405 against at least one parameter threshold 2406 to determine when drive motor 212 is stalling. When the motor stall is detected, motor speed monitor 2204 initiates stall handler 708, which operates as described above.

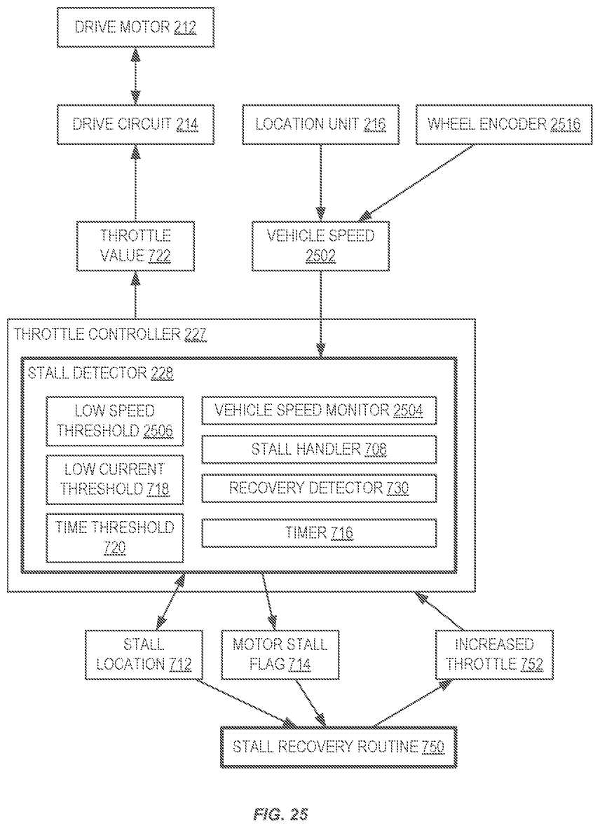

FIG. 25 is a block diagram illustrating stall detector 228 of FIG. 2 configured to monitor speed of tractor 104 to detect motor stall, in embodiments. Stall detector 228 operates as described above with respect to FIG. 7, but includes a vehicle speed monitor 2504 that receives a vehicle speed value 2502 from location unit 216 (e.g., a GPS derived speed and/or an INS derived speed). In certain embodiments, vehicle speed value 2502 is derived from at least one wheel encoder 2516 that defines a rotational rate of at least one wheel of tractor 104. For example, each wheel of tractor 104 may include a wheel encoder 2516, whereby location unit 216 and/or vehicle speed monitor 2504 may detect disagreement between wheel speeds (e.g., left/right or driven/non-driven) to detect and compensate for wheel slippage when determining speed of tractor 104 over the ground. Vehicle speed monitor 2504 determines that drive motor 212 has stalled when vehicle speed value 2502 drops below a low speed threshold 2506 that defines a minimum expected speed of tractor 104 for a particular operation. When the motor stall is detected, motor speed monitor 2104 initiates stall handler 708, which operates as described above.

As described in the examples above, other methods of detecting stall of drive motor 212 may be used and/or combined. In one example, vehicle speed monitor 2504 determines drive motor 212 is stalling when vehicle speed value 2502 differs from a commanded speed of vehicle by more than a threshold value. In another example, vehicle speed monitor 2504 determines drive motor 212 is stalling when a first derivative of vehicle speed value 2502 is greater than a speed change threshold. In another example, where vehicle speed is controlled by a PID function based on vehicle speed, vehicle speed monitor 2504 monitors parameters of PID function 2405 to determine when drive motor 212 is stalling.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for detecting status of a trailer hitched to an autonomous electric tractor, comprising:
receiving, at intervals, a motor current value from a drive circuit of the autonomous electric tractor; and
determining that brakes of the trailer are applied when the motor current value reaches or exceeds a first current threshold.

2. The method of claim 1, further comprising determining the first current threshold based on at least one of a type of the trailer, a weight of the trailer, a length of the trailer.

3. The method of claim 2, further comprising retrieving at least one of the weight of the trailer, the length of the trailer, and the type of the trailer from a yard management system.

4. The method of claim 2, further comprising estimating a weight of the trailer by detecting a force on a fifth-wheel of the autonomous electric tractor when a front of the trailer was lifted by the fifth-wheel.

5. The method of claim 1, further comprising inhibiting a throttle controlling a drive motor of the autonomous electric tractor when the motor current value reaches or exceeds the first current threshold.

6. The method of claim 5, further comprising commanding brakes of the autonomous electric tractor and the trailer to be applied when the motor current value reaches or exceeds the first current threshold.

7. The method of claim 5, further comprising initiating a set of actions when the motor current value reaches or exceeds the first current threshold.

8. The method of claim 7, the set of actions comprising disconnecting and reconnecting a gladhand of the autonomous electric tractor from and to the trailer, respectively.

9. The method of claim 7, the set of actions comprising requesting remote assistance and waiting for the remote assistance to complete.

10. The method of claim 7, the set of actions comprising unhitching the autonomous electric tractor from the trailer, reporting a failure of the trailer move to mission control, and requesting an additional mission.

11. A method for determining a trailer lifted status of a trailer hitched to a tractor, comprising:
receiving input data including at least one of (a) images from a camera mounted on the tractor, (b) a point cloud from at least one LIDAR mounted on the tractor, and (c) radar data from at least one radar mounted on the tractor; and
processing the input data through a neural network to generate the trailer lifted status indicative of whether a landing gear of the trailer as represented in the input data is lifted off a ground on which the trailer is positioned.

12. The method of claim 11, the trailer lifted status further comprising a lift metric indicative of a height of the landing gear off the ground.

13. The method of claim 11, the neural network using a trained model generated from training data that includes images, cloud points, and radar data of hitched trailers in varying states of being lifted.

14. The method of claim 13, further comprising:
capturing a training set having at least one of a training image, a training point cloud, and a training radar data;
annotating the training set to define a ground truth for operating the neural network to determine the trailer lifted status; and
training the neural network using the training set to generate the trained model.

15. The method of claim 14, further comprising annotating the training set to define the ground truth for a height of corresponding landing gear depicted in the training set above the ground, wherein the neural network processes the input data and generates a lift metric indicative of the height above the ground of the landing gear of the trailer hitched to the tractor.

16. The method of claim 14, wherein the training image, the training point cloud, and the training radar data are captured from a camera, a LIDAR, and a radar positioned and oriented as on the tractor.

17. A method for determining a trailer lifted status of a trailer hitched to a tractor, comprising:
receiving, at intervals, a force value indicative of a force imparted by a trailer to a fifth-wheel of the tractor; and
determining the trailer lifted status based on the force value.

18. The method of claim 17, further comprising sensing the force value using a load sensor configured with the fifth-wheel.

19. The method of claim 18, further comprising determining the trailer status as lifted when the force value is above a force threshold.
